(19) United States
(12) Patent Application Publication
(10) Pub. No.: US 2024/0403360 A1
(43) Pub. Date: Dec. 5, 2024

(54) System and Method for Music and Content Recommendation, Identification, Similarity Evaluation, and Matching

(71) Applicant: CARTESIAN THEATRE CORP., Vancouver (CA)

(72) Inventor: Kipling Conrad SINGH WARNER, Vancouver (CA)

(21) Appl. No.: 18/800,499

(22) Filed: Aug. 12, 2024

Related U.S. Application Data
(63) Continuation-in-part of application No. 17/207,458, filed on Mar. 19, 2021, now Pat. No. 12,067,051.
(60) Provisional application No. 62/992,114, filed on Mar. 19, 2020.

(51) Int. Cl. G06F 16/683; G06F 16/632; G06F 16/638

(52) U.S. Cl. CPC G06F 16/683; G06F 16/634; G06F 16/638

(57) ABSTRACT

Systems, devices and methods for analyzing music and other content are provided. In some embodiments, music libraries may be searched by using one or more songs, portions of songs or other segments of music as the search key. Other types of audio and video files may also be searched using similar devices and methods. In other embodiments, a musician or vocalist who sounds similar to another musician or vocalist may be identified. Similarity scores may be generated for music and/or other content that indicate the likelihood that they will be perceived as similar or dissimilar.

### CROSS REFERENCE TO RELATED APPLICATIONS

This application is a continuation-in-part of U.S. patent application Ser. No. 17/207,458 filed Mar. 19, 2021, which claims the benefit of U.S. Provisional Patent Application No. 62/992,114 filed Mar. 19, 2020, the disclosures of which are hereby incorporated by reference herein in their entireties.

### TECHNICAL FIELD

The present disclosure relates to methods and systems for characterization and categorization of audible and other materials. More particularly, the present disclosure relates to methods and systems for identifying music and/or content that is similar to other music and/or content.

### BACKGROUND

Humans have found entertainment, enlightenment, happiness, and community through music from the earliest days of humanity. As the number of humans has risen, so too has the number of musicians and musical works. Humans have reached the point where it is impossible, within a single human lifespan, to listen to all extant music. In fact, estimates are that approximately one thousand songs are uploaded to streaming providers every hour—or around 17 songs every second. Put another way, a human being could listen to music every minute of her life and hear only a tiny percentage of the songs that are available. With the advent of generative AI-assisted music creation, it is likely that the amount of music created will increase by at least an order of magnitude in short order.

With this proliferation of content, it has become literally impossible for a human to find the songs they would most like. Even if a human can identify ten songs they love, those songs cannot be used to accurately predict other songs they would love based solely on information like genre or artist. This is so in part because music recommendations tend to come in the form of “Jim likes Song A and Song B, so if you like Song A, and because I think you are like Jim, you'll likely like Song B.” That would be a statistical based recommendation that operates by profiling users and their listening habits (a kind of symbolic metadata based system). These kinds of recommendation systems are vulnerable to the “cold start problem”. They cannot reliably recommend a new song no one has listened to yet, nor recommend a known song many have already listened to, but to a new user the system knows nothing about. In such a situation, symbolic metadata recommendation engines that operate solely by profiling users and their listening habits fail. Further, there is an issue with cultural, age, and other preferences. Using age as an example, and taking a song by an artist such as Diamante, who produces music reminiscent of 1980's era music, the song “1987” may appeal to both a 60 year old and a 15 year old, but would comprise the only overlap between their tastes. In such a situation, symbolic metadata based systems utterly fail.

In addition, it is often the case that those using music for non-personal reasons, such as synchronizing a musical score to a movie or packaging music for use in a public place, are unable to secure intellectual property rights required for their preferred song. Furthermore, they may wish to create a mood within the film without reusing the same song repeatedly, meaning that a song-alike sound would be highly valuable to identify. Existing technology cannot solve for this at all.

In addition, there is no reliable, automated mechanism to identify works that may infringe intellectual property rights in other works. For example, Song A may use elements derived from Song B in violation of the copyright in Song B. This is a particularly vexing problem with “sampling” (as is the question about whether it is considered fair use under copyright law). Current technology makes it difficult to automatically scan most or all existing music looking for infringing material. Thus, for example, if the author of Song A heard an infringing song coming out of a car stereo in a car next to her, she would have no way to later search for that infringing song.

Modern computer technology is such that computers can do what humans cannot: analyze many lifetimes of music, many orders of magnitude, faster than humans. Unfortunately, while this capability has enabled primitive music fingerprinting (such as that done by Shazam®), the prior art has been unable to identify music people will like, based solely on analysis of the music itself (sub-symbolic analysis). In the same vein, existing technology is incapable of understanding how humans hear music and, thus, cannot use that understanding to identify music that has specified characteristics, such as a similarity with another song.

Another failure of the prior art is the inability to identify similar sub elements of music. For example, a user may wish to hear bands or artists with a voice similar to Mick Jagger, or bands or artists with a guitar player who plays in a manner similar to Jimi Hendrix. Among other things, the inventions disclosed herein overcome those limitations.

It should be understood that the approaches described in this section are approaches that could be pursued but are not necessarily approaches that have been previously conceived or pursued. Therefore, no admission is made, nor should it be assumed, that any of the approaches described in this section qualify as prior art merely by virtue of their inclusion in this section.

### Lexography

“KEY”: in the present disclosure, the term “key” generally refers to a search key. In certain instances, as indicated by the context in which “key” is used, “key” may also refer to a musical “key”, being a group of pitches or a scale that forms the basis of a musical composition.

“EMBEDDING”: in the present disclosure, the term “embedding” generally refers to a Cartesian vector embedded in some arbitrary geometric space, such as, but not limited to, the Euclidean space. The embedding summarizes one or more characteristics of one or more objects. The objects generally refer to songs unless the context indicates otherwise.

“ON-PREMISE”: in the present disclosure, the term “on-premise” generally refers to any location a user may have physical ownership, responsibilities for maintenance, or control over to host and configure their own server software such as that described in this document. This is sometimes referred to in industry as “local”, “in house”, “non-cloud”, “on-premises”, “self-hosted”, and related to describe the deployment model. This is in contrast with hosting server software at a remote facility the user has less control of, such as one they rent from a third-party service provider. The latter is sometimes referred to as a “data centre”, “hosted”, “cloud”, “cloud computing”, “cloud-based”, “off-premise”, “SaaS”, “software as a service”, and related. Although the term “software as a service” and “SaaS” sometimes refer to on-premise deployment for some kinds of server software.

### SUMMARY

The inventions (sometimes called the “system” or “engine”) herein enable a non-obvious, novel way to search small, medium, large, or arbitrarily sized music libraries efficiently. It should be understood that while the term “search” is used herein, it is used as shorthand for the inventions described herein to do music similarity matching and not in the traditional sense of a search such as one may do on YouTube® or Google®. In one aspect, the search is made by using one or more pieces of music itself (whether that piece is a single song or a portion of a song or some other segment of music) as the search key (sub-symbolic analysis). As a lexicographic matter, while we describe using this technology as a music search, recommendation, or discovery engine, unless the context clearly requires otherwise, these inventions may also be used with other audio files and types.

In another aspect, the inventions described herein may also be using for video analysis as well as analysis of other content types.

It should further be understood that while analysis of a full song or portions of a full song is one aspect of the inventions, the inventions may also be applied to analysis of only some elements of a song. Existing technology, such as the Audacity® software, are capable of voice isolation. Similar techniques may be used to isolate other portions of the music, such as drums, guitar, bass, piano, or other elements. In one aspect, each song may be analyzed a plurality of times looking at different elements, generating, for example, analysis of the whole song, the vocals, the guitar, just the instruments, etc. In a further aspect, a musician or vocalist who sounds similar to another musician or vocalist may be identified by looking for similarities in the sounds, or by looking for a threshold number of song matches.

In another aspect, matches may be further made or refined by language analysis. In one variant, the gender, tone, tremor, or cadence of the voice may be used. In another, the words or language spoken may be identified (such as by voice-to-text) and used to force inclusion or exclusion of songs or as one factor among a plurality of factors analyzed. In another, the grade level of the words or word complexity may be used. In another, the Flesch-Kincaid readability test may be used. In another, the subject matter of the words may be used. In another, the amount of time that the voice is out of tune or off pitch, and the amount by which it is out of tune or off pitch, may be used. In another, the use of voice autotune technology and/or the frequency of use of autotune technology may be used. In another, the emotional sentiment may be used.

In one aspect, a user may start with a music library of any size. This library may be a single library owned by a single entity, amalgamated music from multiple labels, independent artists, or publishers, a personal or other music library, online music libraries, or any combination thereof.

The inventions herein further allow a user to receive, analyze and integrate a new supply of music when received. Among other things, the inventions allow users to predict which new music is more likely to generate revenue based on how existing similar music has performed financially (predictive analytics). Furthermore, the inventions may allow users to predict other effects of the music based on effects of similar songs. For example, certain songs may be associated with certain dance styles, and identification of similar sounding songs would likely be associated with those dance styles. Similarly, certain songs may be associated with a calming effect, with certain retail establishments, with music in elevators, or other characteristics, and the inventions used to find music sufficiently similar as to be highly likely to cause similar effects.

In one aspect, a variety of sensors may be utilized to measure human (and/or animal) response to a piece of music, and such response used, in whole or part, to impact recommendations. These sensors may include one or more of accelerometers, strain gauges, temperature, gyroscopes, GPS and LPS, heart rate, heart rate variability, galvanic skin response, EKG/EEG, one or more cameras and/or microphones, forward looking infrared sensors, microexpression and micromovement sensors, blood pressure, pulse oximetry, without limitation to those sensors alone. In one aspect, sensors already present in mobile devices such as watches, smart rings, and phones may be used to gather such data. Such data may be gathered passively and may be done in conjunction with music fingerprinting where the music is ambient and not played through the phone (in which case the identity of the music would be known to the device).

Applications are myriad, and include such uses as a digital jukebox in bars, restaurants, and pubs where patrons are able to play more music like the music they just paid to hear. They could even have playlists automatically curated for them based on a “seed” song or songs provided by either patrons, management for the venue, or another source.

In one aspect, a user may select one or more songs, and until some event (such as the passage of time, use by another user, or otherwise), the digital jukebox will continue to play songs with a high level of similarity to the songs selected by the user. Such use is not limited to digital jukeboxes (which includes software powered physical ones), and may be implemented on personal listening devices, Android-based devices, iOS-based devices, shared listening devices, or other listening devices. Furthermore, music streaming services such as Spotify®, Google Play®, Apple Music®, Netflix®, SiriusXM®, Amazon Music®, and others may use the technology to construct playlists or otherwise recommend music.

In another aspect, a user may create a “playlist” of songs based on a search key song. The inventions may then be used to substitute similar songs in the playlist and/or to supplement the playlist. Thus, for example, a user may listen to a ten-song playlist, and then the technology would play ten additional or substituted songs that each correspond to the songs in the playlist. If multiple key songs are used, the playlist can interpolate between the keys with a variable number of appropriate similar songs. In another aspect, the inventions may be used to update or modify playlists to change licensing costs and/or to comply with licensing requirements. For example, if the license to the song “Patents Rock” is provided to music service M until Jan. 1, 2026, the system may replace “Patents Rock” on all playlists on or before Jan. 1, 2026. Similarly, if pricing for certain songs becomes too high, it may be reasonable to switch out songs for sound-alike songs to reduce licensing costs.

In one aspect, a user may have a music catalogue management platform that record artists, promoters, record labels, and publishers use to securely track distribution or playback of their digital assets. Using the inventions herein, customers of that user may search within the user's own catalogue using the user's platform.

The user may have an online digital music store and want to be able to make intelligent product recommendations to customers based on what songs they already have in their shopping cart before they check out. The inventions disclosed herein provide that capability.

The inventions may be used to augment the efficacy of live human DJs or supplant them entirely. For example, one may have a streaming music service whose DJs need inspiration for coming up with either channel based or custom curated playlists. The inventions described herein dramatically expedite creation of such playlists. Similarly, playlists provided by a customer may be used to generate full DJ sets. In another aspect, plugins are made available to manage music libraries. Indeed, even mid-performance, the inventions may be used to suggest next tracks.

In another aspect, where choreography requires music of a certain level of similarity or of a certain type, the inventions may be used to generate it.

One substantial benefit is the ability to better direct customers. Frequently, customers have examples in mind of what they want to buy or obtain a synchronization license for. They may ask the system “Hey, do you have anything that sounds like this for my documentary, video game, net series, or other commercial production?” The input could be an MP3, some other compressed or uncompressed audio file, or a URL to a song or a video containing a song, such as YouTube® or any other popular music distribution platform. Because the inventions enable searching music for similarity indicators, and in some embodiments, providing a similarity score, using the music itself as the search key, the recommendations made to the customer have a far higher likelihood of leading to a purchase and/or customer satisfaction.

Traditionally, in the absence of such technology, the way this has been done is having humans guess at similarities, incurring substantial costs, providing frequently poor matches, and requiring infeasible amounts of manual human labour which delays the business process sometimes by weeks or months. Certain shortcuts, such as using textual tags (symbolic metadata), could simplify the process while making it far less useful and accurate to a cross-cultural and multilingual planet (a scalability and maintenance nightmare). The bottom line is that existing methods are manual and require listening to a great deal of irrelevant music in the hopes of finding the one on which the client is actually willing to spend money. An alternative, statistical analysis (symbolic metadata) of playlists to determine songs that often are liked by the same person who likes certain other songs, is a similarly poor fit for the task. It should be noted that textual tags may be used in conjunction with the inventions, as may human listening. In one aspect, the inventions may return N songs. Only songs with the textual tag “loud” would then be selected from the list of songs. Similarly, the list of N songs may be presented for human listening to identify the songs within the list that best meet the requirements.

In another aspect, a database with copyright, licensing and/or pricing data may be incorporated into the system. In this way, only songs that are in the public domain, or that are copyrighted by a certain one or more entities, or that would cost less than a set amount may be returned (and/or the returned information may be sorted by and/or labelled with such data).

In one aspect, the inventions herein work by analyzing the actual sound of each audio track provided. This is called sub-symbolic analysis, or sometimes direct recommendation. This may be accomplished, at least in part, by performing a complex digital signal processing analysis on both time and spectral domains. In one implementation, the software actually analyzes music by listening directly to the music rather than just guessing what a user wants based on what it thinks someone like the user listened to before.

The scientific research underlying the inventions combines disparate domains, such as music theory, psychoacoustics, physics, mathematics, computing science, computer engineering, software engineering, neuroscience, law, cryptography, and biological computing.

In one aspect, the inventions may be used to determine a likelihood of copyright infringement. Optionally, similarity measures may be calculated using portions of songs (portions determined either by splitting based on intra-song similarity, which would be useful for a song such as Queen's Bohemian Rhapsody, or by splitting based on timing, such as every multiple of 5 seconds). Other songs or song portions that exceed a certain matching (similarity) score are considered likely candidates for copyright infringement. Such a system may also be used to identify infringement of audio trademarks.

Another aspect of the engine is that it is frequently desirable to add music or sound of a certain qualitative nature to materials such as film, TV, documentaries, commercials, video games, etc. (a synchronization license in the case of music). If, for example, a filmmaker wanted to have an uplifting song with a similar feel and sound to the Beatles' “Here Comes the Sun”, it would be possible to simply ask the engine for a list of songs that meet those criteria. Similarly, a data field or fields may be used to track the license status of music, and may then be used to narrow any searches. For example, the filmmaker may wish to find royalty-free songs that may be used commercially and have a similar feel to “Taxman” by the Beatles. While The Jam's “Start” is eerily similar in many aspects to “Taxman”, the database may return a license fee amount or simply may exclude the song because it is not royalty-free.

In another aspect, the similarity matching may be performed by utilizing a plurality of songs or song components to generate the search key. For example, a combination of “Strawberry Fields Forever” and “Black Dog” may be used to find a song that shares the upbeat feel of Strawberry Fields Forever and the fortitude of Black Dog. In one aspect this may be accomplished by interpolating the metrics. In another aspect, it may be accomplished by looking for other songs with portions that share similar metrics. If, for example, one enjoys the combination of styles in “Bohemian Rhapsody”, the metrics generated by analysis of the different portions of that song may be used to search for another song with a similar set of keys associated with different portions of the song.

It should also be understood that the similarity matching engine may be used to make a song sound more similar or different when compared to another song. As a simple example, a song in the key of D may be changed to C in order to be more similar to a song in the key of C. So too may the tempo be altered, the equalization modified, or other characteristics changed. In one aspect, the key in which the song is written may be used as part of a search criteria key. In another aspect, the key may be ignored or simply used to weight results.

### BRIEF DESCRIPTION OF THE DRAWINGS

The accompanying drawings illustrate non-limiting example embodiments of the invention.

FIGS. 1A & 1B show pseudo code for selecting the most appropriate image artwork for a corresponding stream.

FIG. 2 is a diagram showing three songs in a 3-dimensional Euclidean space, with each axis representing a feature dimension, according to an example embodiment of the present invention.

FIG. 3 is an exemplary implementation of one aspect of the inventions in a block diagram.

### DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications, and equivalents that may be included within the scope of the invention as defined by the appended claims. Furthermore, in the following detailed description, numerous specific details are set forth in order to provide a thorough understanding of the present invention. However, it will be readily apparent to one skilled in the art that the present invention may be practised without these specific details. In other instances, well-known methods, procedures and components have not been described in detail so as not to unnecessarily obscure aspects of the present invention. These conventions are intended to make the present disclosure more easily understood by those practising or improving on the invention, and it should be appreciated that the level of detail provided should not be interpreted as an indication as to whether such instances, methods, procedures or components are known in the art, novel, or obvious.

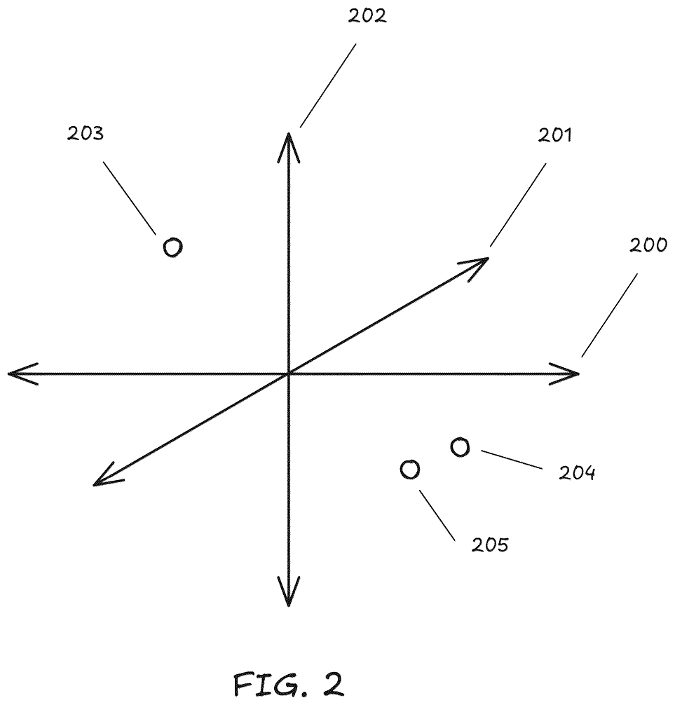

Turning to FIG. 2, we see placement of content, for example songs, within an N-dimensional space where, in this illustration, N=3. Because of the limitations of current drawing technology in showing dimensions greater than 3, the presence of additional dimensions are not illustrated. However, the use of three dimensions is meant to be an example, and should not be interpreted as limiting.

In FIG. 2, there is X-axis 200, Z-axis 201 and Y-axis 202. Each of the axes 200, 201 and 202 represent a feature (e.g., gender of vocalist, tone, cadence, zero crossing rate, spectral centroid, an emotional sentiment, etc.) on which songs will be evaluated. We see the first song 203 is relatively distant from the second song 204 and third song 205. When seeking songs that are similar, the relative proximity of the second and third songs 204 and 205 indicates that they have a higher level of similarity to each other than either of those songs bears to the first song 203 in terms of the angle formed between the vectors. This relative similarity is computed using cosine similarity (or cosine distance) of the songs' respective vector embeddings, but other embodiments may rely on alternative distance metrics in a metric or non-metric space.

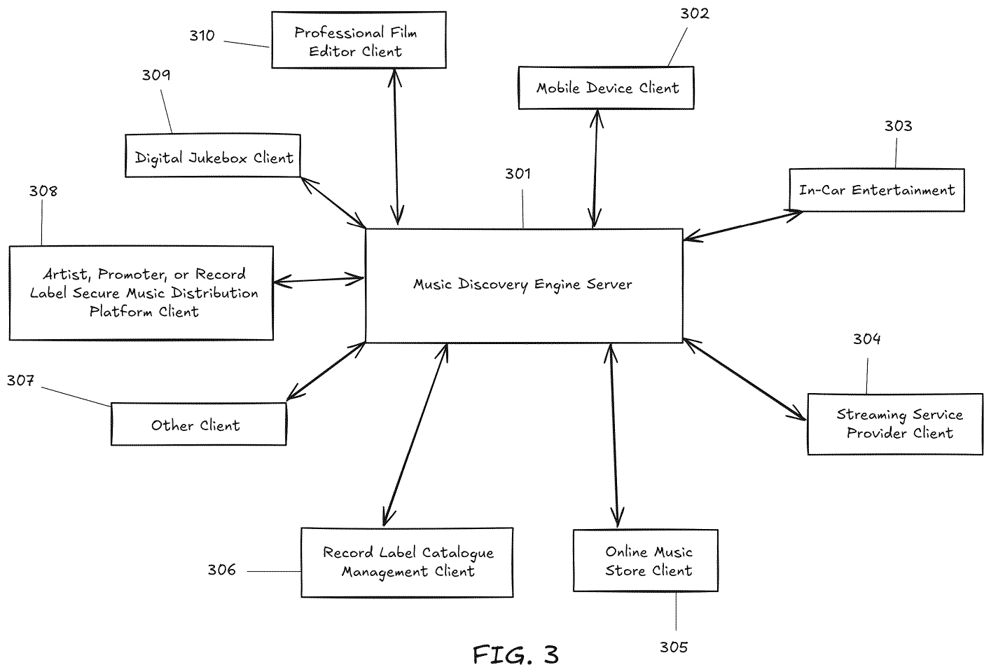

Turning to FIG. 3, we show a component diagram of one aspect of the invention. A music discovery engine server (“MDES”) 301 is operably connected to one or more of a variety of clients, including a mobile device client 302, an in-car entertainment client 303, a streaming service provider client 304, an online music store client 305, a record label catalogue management client 306, an artist, promoter, or record label secure music distribution platform client 308, a digital jukebox client 309, a professional film editor client 310, and some other client 307. In some instances, an application programming (API) interface is utilized.

A client-server architecture may be utilized with the server exporting an API. The server can be hosted on-premise or any other location a person desires. This is possible because the server is designed to be portable across different hardware instruction set architectures (ISAs) and optionally leverage commodity computing hardware that is readily available to users (including RISC-V, ARM, POWER and others). This flexibility in server deployment allows a person to limit transmission of any portion of their music to their local network or other infrastructure and to have all important computations performed at a location of their choosing where all relevant data is stored. This can significantly mitigate privacy concerns, security issues, regulatory restrictions, bandwidth limitations, an underwriters' risk exposures, and other concerns. The API may be available via Representational State Transfer (REST) architecture, inter-process communication, dynamic or static linkage, or other means.

The described systems and processes merely exemplify various embodiments of enhanced features. The present technology is not limited by these examples.

### Acoustic Analysis:

The analysis of an audio signal includes its time and spectral domains. This process extracts a set of quantifiable metrics which may include one or more block feature vectors through mathematical and/or digital signal processing. “Block features” is sometimes used interchangeably with “block feature vector” in this document. By “block” we mean a specific kind of vector whose individual components or features each describe the behaviour of some aspect of the audio waveform for a fixed duration of time, as opposed to a specific instant, sample, or audio frame.

The process begins with the source audio samples being decoded and resampled from their source format, such as from FLAC (Free Lossless Audio Codec) compressed 96 KHz 5.1 surround sound to PCM (pulse code modulated) 44.1 KHz single channel, single precision, floating point samples. This ensures there is no bias based on the input format if all processing is performed on the latter uniform format.

Songs are usually not recorded with consistent loudness. Some songs might be recorded with a higher apparent loudness than others. Sometimes this is intentional, as in the “loudness war”. It is therefore helpful in some embodiments to automatically apply a standardized loudness to each song during its resampling before analysis is performed. This process is called loudness normalization where the gain (amplitude) of every sample is adjusted to bring the average loudness of the song to a consistent level. The gain to be applied can either be determined from within the song's symbolic metadata provided by the user or automatically calculated.

A sliding signal window queue of two steps of 512 samples each, totalling 1024 samples, is loaded from the decoded and resampled audio. Each time the queue is updated after analysis, the oldest step is discarded, its neighbour shifted into its place, and the step containing the newest decoded samples inserted into the queue. The queue is analyzed before it is updated again. This means every step is processed twice.

The sliding signal window has time and spectral domain descriptors extracted. Every time this is done, a new window descriptor vector is created containing the values of the extracted signal and spectral descriptors. After every 150 window descriptor vectors have been accumulated (approximately 3.48 seconds of audio), each descriptor is traversed over the list of 150 to generate a block feature vector containing the statistical moments for the mean, variance, skewness, and kurtosis. Other embodiments may substitute 150 with another integer value. This resulting block feature vector summarizes how the waveform behaved for that period of time.

The analyzed and/or extracted time domain descriptors may include, but are not limited to, one or more of the zero crossing rate, first order autocorrelation or noisiness, energy or loudness. Additionally frequency domain descriptors may include, but are not limited to, the timbre or linear regression, spectral centroid, spectral smoothness, spectral spread, and the spectral dissymmetry.

Each generated block feature vector is appended to a list for the given song. After all samples from the source have been processed, every window descriptor vector is processed again to generate another block feature vector for the entire song. This ensures there is a single song-level block feature vector that summarizes the entire song's average timbre, along with a list of block-level feature vectors that capture a finer level of granularity of every 3.48 seconds of the song. Both the song and block-level feature vectors are later used to prepare an index necessary to perform similarity matching.

It should be understood that the extracted features may be incorporated into metadata or textual data associated with a song. In this way, for example, a song with a rapid beat may have the textual data “fast” associated with it, allowing other software to search for the textual data without having to further utilize the inventions. In one aspect, saving such data may function to separate the search function from the analysis function.

After song and block-level feature vectors have been generated, min-max scaling is performed to normalize the features to protect from bias. In other embodiments other forms of feature scaling may be used. In some embodiments, one or both of the song and block level feature vectors are each min-max normalized to a range of [−1, 1]. The formula for min-max scaling is provided below to scale some value: x∈R to be within the range of [a, b]:

$${x}^{′} = a + \frac{( x - min ( X ) ) ( b - a )}{max ( X ) - min ( X )} \vert a < b ∧ a , b ∈ ℝ$$

The min and max functions are defined as follows:

$$min ( X ) ∈ X \vert ∀ {x}_{i} ∈ X , min ( X ) \leq {x}_{i}$$

$$max ( X ) ∈ X \vert ∀ {x}_{i} ∈ X , {x}_{i} \leq max ( X )$$

Note that the range is somewhat arbitrary as long as it is used consistently. The range of [−1, 1] was selected in one embodiment because the greatest number of representable floating point values fall within the range of zero to unity in an IEEE 754 encoded value. Allowing for signed values further adds for greater flexibility when computing and using vector embeddings.

In one implementation, the feature extraction processing is performed on each song added to the catalogue in a single pass with optimizations for SIMD vectorization and parallel execution across multi-core heterogeneous computing units. It should be understood that multiple passes may be used, some or all actions performed in sequence or serial, one or more single-core devices may be used, and the one or more computing units may be homogeneous in whole or part. Furthermore, it should be understood that some or all of the computing may be accomplished using a quantum computer, a single or multi-core graphics card, field-programmable gate array, physics processing unit, digital signal processor, accelerated processing unit, audio processing unit, or other computing technology.

The system optimizes for spatial and temporal locality in how block feature vectors are stored. Each song's song-level block feature and block-level block feature vectors are sorted and stored contiguously in internal high performance data structures to minimize CPU cache miss latency. This also allows fast ordered traversals when necessary.

### Searching:

One or more of the song's song-level block feature vector and its block-level feature vectors are selected, converted into matrix form, weights are applied to scale some or all of their values, and the resulting matrices are combined into a single vector embedding as some K-dimensional coordinate in a geometric space for every song or portions thereof. In one embodiment these vector embeddings may be compressed through dimensional reduction, such as through principal component analysis (PCA).

In one embodiment each song's embedding is indexed in a hierarchical navigable small world graph data structure (HNSW). The HNSW is similar to a skip list, but replaces its linked list with proximity graphs. This allows for, on average, logarithmic queries with a higher recall rate (better quality matches) than the previous state of the art available through locality-sensitive hashing. Using a k-ANN algorithm also avoids the plague of brute force linear search times that inevitably come from higher dimensional data with k-d trees or other k-NN algorithms. Thus, the system can scale to any size catalogue limited only by practical hardware constraints, such as disk, RAM, and bandwidth.

In other embodiments the indexing of each song's embedding may rely on different data structures or algorithms. For this reason in certain implementations, in one aspect our system would not use the above described technique and/or may rely on other advanced optimizations, algorithms and storage techniques, to prune or index the search space. These include alternative directed or undirected graphs, trees, hashing, and min-max heaps. This ensures that the time and space complexities necessary to complete a query are practical, regardless of the size of the music catalogue. But other embodiments may include a flat index approach whereby similarity between songs is tracked during a query within a min-max heap as the catalogue is traversed. This would have a negligible performance penalty when used with a small catalogue while affording the benefit of perfect recall.

Similar songs are identified in the HNSW via cosine similarity between their respective vector embeddings. The advantage of cosine similarity is that it is not affected by songs varying in length. Songs that vary in length may generate different magnitudes for their computed vector embeddings. But the foregoing implementation should not be viewed as limiting, as the inventions may be conceptualized using other modes for determination of the level of similarity such as the L1 Manhattan norm, L2 Euclidean norm, squared L2 norm, max norm, Hamming distance, and related.

In one implementation, this analysis is limited to only the extent necessary as dictated by the application for which the analysis will be used. These block features vectors, or audio characteristics, are stored in an internal database while the song's symbolic metadata is stored in an external database (RDBMS or other DBMS format). The external database also stores a copy of every song's block feature vectors offline so that the system can restore its state after the system is brought online again. The internal database forms a component of the system with the system being able to query it later to obtain a ranked (sorted) listing of songs similar to that used as the audio search key. The search key may already be a song within the database or a song from an external source as previously discussed. The ranked listing can be used for any number of different use cases as described elsewhere in this document.

### Dynamic Block Feature Vector Normalization:

In some embodiments, a database of songs and associated block feature vectors are dynamically normalized each time a new song is added to the database. Because this is a computationally costly O(N) operation this should be performed only when absolutely necessary.

Such dynamic normalization may comprise: receiving a current feature range for a feature type; extracting a feature of the feature type from the new song; determining whether the extracted feature is outside of the current feature range; normalizing the associated features; updating the current feature range based, at least in part, on the extracted feature; generating fresh song embeddings; and re-indexing those embeddings.

The dynamic normalization may further comprise generating a renormalization probability, and renormalizing the associated features and updating the current feature range based at least in part on the renormalization probability; wherein the renormalization probability represents the probability that adding the new song and extracted feature to the database requires a renormalization of the database.

Each time a new song is added or deleted, each component in the block feature vectors is compared against the corresponding currently tracked minimum and maximum values for that feature. If the song that is to be added generated a feature that was outside the currently tracked range for that feature, then the tracked minimum and maximum ranges (extremums) are updated and the database renormalized. If the song to be deleted had contributed one or more extremums then the extremums are updated and the database renormalized.

When a database is initially being populated with songs, there is a high renormalization probability with each new song. Since the database then is small, renormalization is nevertheless fast. But as the database increases in size, the renormalization probability scales inversely to the size of the catalogue because the system has already had an opportunity to examine more feature values.

### Triplet Mining and Training:

Recall that the system's similarity matching functionality depends on weights (sometimes referred to as a “learning model”). Each of the block feature vector components has a weight assigned when an embedding is computed. Additionally, there are further weights governing how the song-level and block-level feature vectors for a song separately contribute to the resulting embedding.

We have discussed in this document how the cosine similarity is used to compute the similarity between two songs, but not how the weights were determined prior to being applied to the computation of each song's vector embedding. These weights are important because not all features will necessarily contribute equally. The smaller the feature weight the less that feature will contribute to the overall calculation.

The entire computation to generate each song's vector embedding is differentiable. This is necessary to ensure that numerical analysis can be performed to search for optimal weights when training. A partial derivative for each dimension (weight) acts like a compass guiding the optimizer while it travels around in a large multidimensional space searching for a model that minimizes a triplet loss cost function. The latter is provided as input triplet training examples that will be described shortly.

Convergence on an optimal solution is similar to trying to tune a radio with several knobs. Turning each a little at a time is followed by listening for any change in static. More static means a higher cost. For the system a good solution is a vector of weights or a model that performs well (has a low cost) on both a training and a test set.

The system ships with default weights that are generally adequate, but are not “baked” into it. These weights can be re-calibrated or trained by the user. In doing so the quality of similarity matches may be improved.

The system has in one embodiment an API to enable training of the system. The system also includes various software utilities that interact with that API to allow users to generate learning example triplet data and have the system train itself based on that new data. One of those software utilities will be referred to in this document as the “Trainer”.

The Trainer provides a music expert with a graphical user interface to facilitate the system's supervised learning by obtaining ground truth from the expert. In other embodiments the supervised learning need not have a GUI, but rely on a command line, API, web-based, voice activated, or other interface. The user is presented with a randomly selected search key song from the system's database along with N-ranked songs similar to the search key. The user is given the opportunity to listen to the search key and each of the proposed matches in the system's ranked list. The user can optionally remove or re-order any of the system's proposed matches into a user list as they like. When the user is satisfied with their new list, that list is then used to automatically “mine” or generate new learning example triplets. The process repeats for as many search key songs as the user likes.

Training of the system is performed on triplet learning examples, or groupings of three songs. Each triplet learning example is a 3-tuple that references an anchor, a positive, and a negative song. The anchor is a search key song. The positive is any song that is relatively more similar to the anchor than the negative. That is, the positive has a lower ranking than the negative.

The more learning examples the more likely the system will be able to improve the quality of its similarity matching. The whole purpose of the Trainer is to accumulate as many of these learning examples deductively.

The system “mines” or generates learning examples based on the search key, the system ranked list, and the user ranked list.

The triplet loss cost function effectively measures the distance between an actual and a predicted value, allowing the computation of an appropriate embedding function ƒ.

In learning the embedding function ƒ we are trying to figure out how to assign embeddings to the songs such that dissimilarity, similarity, or ordinal relations between those objects, like our learning example triplet predicates, will have those relations obeyed as closely as possible (multidimensional scaling).

Because the system is looking for embeddings that respect only the relative ordering of the input dissimilarities, as opposed to exact quantitative measures of dissimilarity, this is a non-metric MDS. Non-metric MDS is useful in this context because it is difficult to quantify the magnitude of the songs' dissimilarities by a user. For example the user knows that the positive song is more similar to the anchor song than the negative, but they cannot say that this is so by 36.7%.

The system's approach relies on contrastive learning. This is because it uses both positive and negative examples. The loss function minimizes the cosine similarity between the positive examples while maximizing the cosine similarity between the negative ones.

The Trainer performs a weak form of supervised learning. It is “weak” because, as discussed, the user need not provide an exact measure of similarity between each of the ranked songs. They need only provide a relative order of similarity.

The overall cost for all triplets is the summation of the individual cost L of each i^{th} learning example as parameterized by the given candidate weight vector \vec{θ}. This is determined by the following overall cost function:

$$J ( \vec{θ} ) = {\sum }_{i = 1}^{m} {L}_{\vec{θ}} ( {A}^{( i )} , {P}^{( i )} , {N}^{( i )} )$$

The system generated ranked list of songs R^{H}(tₛ) is ordered in descending similarity from the search key tₛ. This list is denoted by the following formula where N_{H} is the length of the system generated list:

$${R}^{H} ( {t}_{s} ) = [ {r}_{0}^{H} ( {t}_{s} ) , {r}_{1}^{H} ( {t}_{s} ) , … , {r}_{{N}_{H} - 1}^{H} ( {t}_{s} ) ]$$

The user ranked list R^{U}(tₛ) is denoted below, also as a function of tₛ, where N_{U} is the length of the user generated list. Because this list is generated by an expert it is assumed to be ground truth:

$${R}^{U} ( {t}_{s} ) = [ {r}_{0}^{U} ( {t}_{s} ) , {r}_{1}^{U} ( {t}_{s} ) , … , {r}_{{N}_{U} - 1}^{U} ( {t}_{s} ) ]$$

The following constraints are always applied to the system and user rankings because the user generated list's songs are always selected from the list generated by the system:

$$\vert {R}^{U} ( {t}_{s} ) \vert \leq \vert {R}^{H} ( {t}_{s} ) \vert$$

$${N}_{U} \leq {N}_{H}$$

Note that the above is somewhat of an abuse of set notation since lists are ordered whereas sets are not. Further, although lists in a mathematical sense are not guaranteed to be free of duplicates, for our purposes in the aforementioned they never do.

Our goal is to mine as many triplet learning examples as possible. Selecting an anchor is simple, it is just the search key. Selecting a positive example Pᵢ can be determined like so:

$${P}_{i} ∈ ( P = {R}^{U} ( {t}_{s} ) - {r}_{{N}_{u} - 1}^{U} ( {t}_{s} ) )$$

This says that a positive example is taken from any song in the ranked user list, except the last one. This is because if we allowed choosing the N^{th} similar song as a positive that would mean there could be nothing less similar to it to select to act as a negative.

Choosing a negative Nⱼ example can be determined from the following formula. That is the Nⱼ is taken from the set generated by the set generator function N*:

$${N}_{j} ∈ {N}^{*} ( {P}_{i} , {R}^{H} , {R}^{U} )$$

The set generator function is defined below. It is a function that generates the set of all negative examples as a function of the selected positive example Pᵢ, the system generated list R^{H}, and the user permuted list R^{U}:

$${N}^{*} ( {P}_{i} , {R}^{H} , {R}^{U} ) = ( {R}^{U} ( {t}_{s} ) - \{ {r}^{U} ( {t}_{s} ) , … , {r}_{i}^{U} ( {t}_{s} ) \} ) ⋃ ( {R}^{H} ( {t}_{s} ) - {R}^{U} ( {t}_{s} ) )$$

The set generation is performed with the union of two sets. The first term in the union starts by constructing a set from the user permuted list, removing all songs that were more similar to the anchor A than the positive Pᵢ, including the positive itself.

The second term in the union is every song the user did not select from R^{H} to assign to the R^{U} list. In other words the set generator function can be used to derive learning example triplets deductively from the choices the user did not make. If the user assigned only a single song to the user ranked list, then we can infer that every other song in the system ranking was a bad recommendation and should be less similar to the anchor than the only positive.

The resulting set of all possible triplets the system mines is therefore defined by the set τ in the annotated formula below:

$$τ = \{ {\overbrace{〈 A , {P}_{i} , {N}_{j} 〉}}^{triplet} \vert {\underbrace{A = {t}_{s}}}_{anchor} , {\overbrace{〈 {P}_{i} , {N}_{j} 〉 ∈ ( P \times {N}^{*} ( {P}_{i} , {R}^{H} , {R}^{U} ) )}}^{every pair of positive and negative example} \}$$

The above triplet mining algorithm scales cubically as O(N_{H}³) with respect to the length of the system ranked list. However, since the length of the latter is short this is immaterial to the performance of the system.

The generated triplet examples when submitted to the system for training a learning model are divided randomly into a training and test set with respective allocations of 80% and 20% in one embodiment. The training set is what the system uses to actually perform numerical optimization on.

The test set is used after optimization to compare the accuracy of the learned model by counting the number of triplets, treated as if they were logical predicates, that still hold as true. That is, how many triplets in the test set have a positive that was more proximate to the anchor than the negative after all three were embedded in some geometric space using the given model.

If available the system will leverage a graphics processing unit for hardware acceleration during training, but one is not required.

### Artwork Automated Selection & Extraction:

During audio analysis, embedded symbolic metadata, such as artist name, title, album, ISRC code, and related information may be provided by the user or extracted from the audio stream automatically and stored within an appropriate database. This symbolic metadata is associated with each song admitted into the catalogue and may be useful for users who wish to perform queries that benefit from knowing additional descriptive information about the music in the database. In one aspect, performing a similarity match should always provide in the ranked listing various song symbolic metadata, such as artist and title, as opposed to a potentially non-descriptive file name or merely some kind of unique database integer identifier or alphanumeric string reference.

The system, if requested, can also provide a user with an appropriate piece of image artwork for any song that has embedded one within its binary stream when admitted into the system's catalogue. The method the system uses performs this task without needing to analyze any song. That is, it does not need to decode any samples from the given song or any other song. No audio analysis needs to be performed for automatic artwork selection. But the challenge is in determining how the system should automatically select the best image in situations where the binary stream contains more than one.

In one aspect, an additional data point or data points may be derived from image analysis. For example, a full image of the band would reveal how many members there are, and would be useful in a search such as one for solo artists.

Why would a user request artwork? Consider the scenario where they have an online music store that is enabled by this system in its backend. The songs listed on the website and their associated information are all pulled from within the system's database and various recommendations are made from time to time to the user's customers based on what is already in their shopping cart. Other applications include displaying it to the user on a portable device, an in-car or in-flight entertainment console, an online streaming platform, or other applications.

In one aspect, images may be introduced in a cloud-style presentation, where images associated with songs that are proximate on similarity markers, enabling a more flexible method for presenting information about similar songs. In one implementation, the proximity of songs in a K′-dimensional space may be measured and used to construct a cloud in 2 or 3 dimensional space to visually present a user with similar songs from which to further proceed with their desired use.

Consider the scenario where the user queries the system to generate a browser rendered catalogue with each song ideally, for certain use cases, having a single piece of artwork to display as a thumbnail somewhere appropriate on the website. In other use cases, multiple images may be utilized for one or more songs. In most cases, the user needs only one image per song, and ideally the best one. In some implementations, the system would be better off providing the album cover, as opposed to the inside of the jewel case, the back cover, or a photograph of the vinyl or optical media itself, though other implementations may utilize those other image sources or image sources not referenced above.

Many audio files in the wild contain image data, but without proper metadata descriptors identifying which image is the album cover. Further, audio files in the wild can be encoded in any number of different codecs, such as FLAC, Vorbis, MP3; and, in turn, stored within any number of different kinds of containers such as Ogg, MPEG, and so forth. Within a file container there could be any number of different streams. A stream could represent compressed audio, video, subtitles, images, or other data. In the case of image data, it sometimes has no useful associated semantic hints.

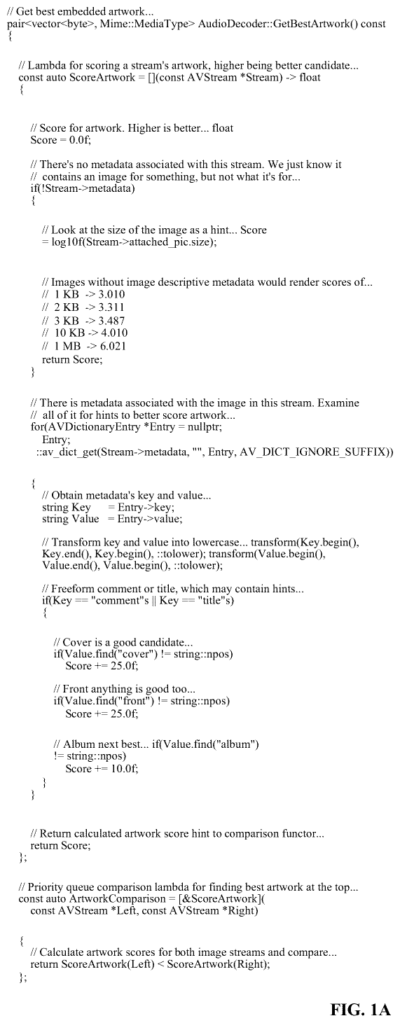

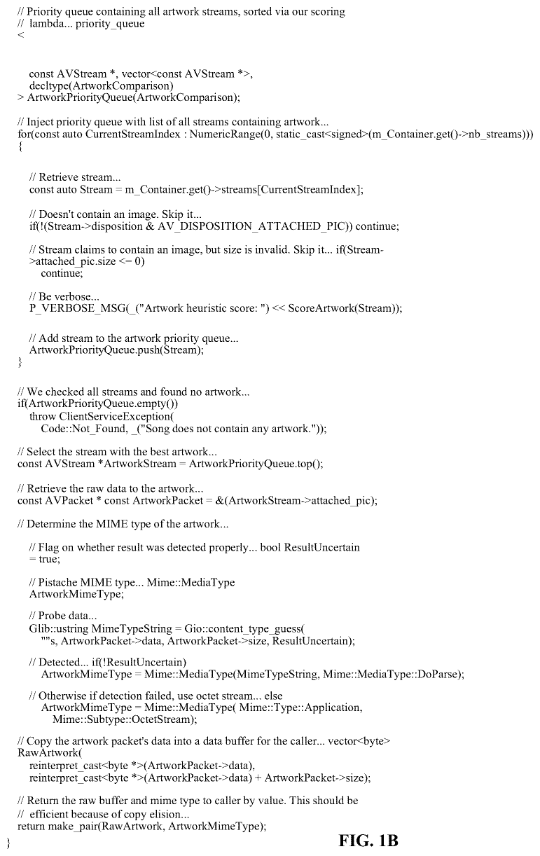

In a preferred implementation, the system uses a simple, but intelligent algorithm that has performed well during field testing to select the most appropriate image artwork. It works by computing a heuristic score for each stream of non-zero size that purportedly contains an image. It injects that stream's ordinal as placed within its parent container format into a priority queue. The priority queue is sorted on each injection with a lambda functor that computes scores based on the quality of the image within the image stream. Retrieving the first element after traversing all candidate streams will select the stream with the highest (best) score. FIGS. 1A and 1B show pseudo code for one embodiment of this algorithm.

The heuristic begins by initializing an image stream's score to zero. If the stream does not contain any descriptive metadata to describe the artwork, it is first set to the base ten logarithm of the size of the stream. Artwork that is one kilobyte in size would therefore score 3.010, two kilobytes at 3.311, three kilobytes at 3.487, ten kilobytes at 4.010, one megabyte at 6.021, and so forth. This ensures that the best artwork, even without any other descriptive hints, still has a chance of being discovered.

Next the stream's score is potentially increased further if it contains an appropriate freeform textual tag, such as “cover”, “front”, or “album”. Empirical research has demonstrated this to be common in the wild.

At this stage the most appropriate image artwork is almost always at the head of the priority queue. Once selected the stream's payload is probed to determine the MIME type, such as JPEG or PNG, so the user will know how to decode the binary data. The data and MIME type are then returned to the user for rendering in whatever manner may be appropriate for their use case.

### System Architecture:

A unique characteristic of the system is its architecture. Users have control over where the system is hosted. They are not confined to using a single central provider, but may host wherever it is that is most convenient for the user. This is essential because it is not unusual for record labels and other music related businesses to prohibit their music from leaving their local network for legal or other internal policy reasons. Our system's architectural design circumvents this or similar restrictions by allowing the user to perform all music analysis directly on-premise, or wherever is practical for them, along with the storage of all essential data.

In some embodiments, the system may be divided into a primary server, database backend, client utilities, sample software development kit (SDK), license server, documentation, and a default configuration.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

### Some Embodiments

One embodiment of the present invention provides a method for selecting a song from a plurality of songs, the method comprising: receiving the plurality of songs; generating one or more block feature vectors for each song in the plurality of songs; maintaining a list of block feature vectors for each song in the plurality of songs; normalizing the block feature vectors; receiving a request comprising a search key song; generating one or more block feature vectors for the search key song; and selecting a song from the plurality of songs based on a similarity between the block feature vectors of the selected song and the block feature vectors of the search key song.

In some embodiments, the similarity between the block feature vectors of the selected song and the block feature vectors of the search key song comprises a proximity between the block feature vectors of the selected song and the block feature vectors of the search key song.

In some embodiments, generating the block feature vectors comprises extracting one or both of time and spectral domain descriptors.

In some embodiments, the time and spectral domain descriptors include one or more of: a zero crossing rate, a first order autocorrelation, an energy level, a linear regression, a spectral centroid, a spectral smoothness, a spectral spread, and a spectral dissymmetry.

In some embodiments, generating the block feature vectors comprises generating one or more statistical moments of the extracted time and spectral domain descriptors.

In some embodiments, the statistical moments comprise one or more of: a mean, a variance, a skewness, and a kurtosis.

In some embodiments, generating the block feature vectors comprises generating the block feature vectors via a sliding signal window.

Some embodiments comprise range scaling the block feature vectors.

In some embodiments, wherein maintaining the list of block feature vectors comprises, for each of the plurality of songs, indexing a combination of one or more of the block feature vectors for the song in a hierarchical navigable small world graph data structure.

Some embodiments comprise adding an additional song to the plurality of songs and updating the list of block feature vectors by: generating one or more block feature vectors for the additional song; and adding the block feature vectors for the additional song to the list of block feature vectors.

Some embodiments comprise: determining the list of block feature vectors requires renormalization; and renormalization the list of block feature vectors.

In some embodiments, determining the list of block feature vectors requires renormalization comprises: determining a feature range from the list of block feature vectors; and determining one or more of the block feature vectors for the additional song are outside of the feature range.

One embodiment of the present invention provides a system for selecting a song from a plurality of songs, the system comprising: one or more processors; one or more computer-readable media storing computer-executable instructions that, when executed on the one or more processors, cause the one or more processors to perform acts comprising: receiving the plurality of songs; generating one or more block feature vectors for each song in the plurality of songs; maintaining a list of block feature vectors for each song in the plurality of songs; normalizing the block feature vectors; receiving a request comprising a search key song; generating one or more block feature vectors for the search key song; and selecting a song from the plurality of songs based on a similarity between the block feature vectors of the selected song and the block feature vectors of the search key song.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.
Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.
Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”)). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

In addition, while elements are at times shown as being performed sequentially, they may instead be performed simultaneously or in different sequences. It is therefore intended that the following claims are interpreted to include all such variations as are within their intended scope.

Software and other modules may reside on servers, workstations, personal computers, tablet computers, image data encoders, image data decoders, PDAs, color-grading tools, video projectors, audio-visual receivers, displays (such as televisions), digital cinema projectors, media players, and other devices suitable for the purposes described herein. Those skilled in the relevant art will appreciate that aspects of the system can be practised with other communications, data processing, or computer system configurations, including: Internet appliances, hand-held devices (including personal digital assistants (PDAs)), wearable computers, all manner of cellular or mobile phones, multi-processor systems, microprocessor-based or programmable consumer electronics (e.g., video projectors, audio-visual receivers, displays, such as televisions, and the like), set-top boxes, color-grading tools, network PCs, mini-computers, mainframe computers, and the like.

The invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

In some embodiments, the invention may be implemented in software. For greater clarity, “software” includes any instructions executed on a processor, and may include (but is not limited to) firmware, resident software, microcode, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Some embodiments and/or features of the present invention may comprise or reference artificial intelligence (AI), including machine learning (ML). Where a feature of the present invention is described as comprising a machine learning algorithm, unless otherwise stated, the machine learning algorithm may comprise one or more of:
an untrained machine learning model;
a trained machine learning model, for example a training convolutional neural network (CNN), recurrent neural network (RNN), genetic algorithm, and the like;
a lookup table; and
a software algorithm.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A system, comprising:
one or more processors;
one or more computer-readable media storing computer-executable instructions that, when executed on the one or more processors, cause the one or more processors to perform acts comprising:
generating one or more block feature vectors for each song of a plurality of songs, including by:
extracting time and spectral domain descriptors, wherein the descriptors include one or more of: a zero crossing rate, a first order autocorrelation, an energy level, a linear regression, a spectral centroid, a spectral smoothness, a spectral spread, and a spectral dissymmetry,
one or more statistical moments of the extracted time and spectral domain descriptors, and
maintaining a list of block feature vectors for each song in the plurality of songs;
normalizing the block feature vectors;
receiving a request comprising a search key; and
determining one or more results based on a proximity of the search key to the plurality of songs.

2. The system of claim 1, wherein extracting the time and spectral domain descriptors comprises extracting the time and spectral domain descriptors via a sliding signal window.

3. The system of claim 1, further comprising: generating textual song metadata from the time and spectral domain descriptors.

4. The system of claim 1, wherein the search key is the identity of a song.

5. The system of claim 1, wherein the search key is music.

6. The system of claim 1, wherein receiving a request comprising a plurality of search keys in which the search keys are interpolated to form a single search key.

7. The system of claim 1, further comprising: selecting an embedded artwork for a song based on a heuristic score.

8. A method, comprising:
generating one or more block feature vectors for each song of a plurality of songs, including from:
extracting time and spectral domain descriptors, wherein the descriptors include one or more of: a zero crossing rate, a first order autocorrelation, an energy level, a linear regression, a spectral centroid, a spectral smoothness, a spectral spread, and a spectral dissymmetry, one or more statistical moments for extracted time and spectral domain descriptors, and
maintaining a list of block feature vectors for each song in the plurality of songs;
normalizing the block feature vectors;
receiving a request comprising a search key; and
determining one or more results based on a proximity of the search key to the plurality of songs.

9. The method of claim 8, wherein extracting the time and spectral domain descriptors comprises extracting the time and spectral domain descriptor via a sliding signal window.

10. The method of claim 8, further comprising: generating textual song metadata from the time and spectral domain descriptors.

11. The method of claim 8, wherein the search key is the identity of a song.

12. The method of claim 8, wherein the search key is music.

13. The system of claim 8, wherein receiving a request comprising a plurality of search keys in which the search keys are interpolated to form a single search key.

14. The system of claim 8, further comprising: selecting an embedded artwork for a song based on a heuristic score.

15. The system of claim 1, wherein one or more of each song's block feature vectors are weighted and combined into a single vector embedding.

16. The method of claim 8, wherein one or more of each song's block feature vectors are weighted and combined into a single vector embedding.

17. The system of claim 15, wherein proximity of the search key to the plurality of songs is determined in, on average, logarithmic time with respect to the total number of songs known to the system.

18. The method of claim 16, wherein proximity of the search key to the plurality of songs is determined in, on average, logarithmic time with respect to the total number of songs known to the method.

19. The system of claim 15, wherein proximity of the search key to the plurality of songs is determined via the cosine similarity between the search key's vector embedding and those of the plurality of songs.

20. The method of claim 16, wherein proximity of the search key to the plurality of songs is determined via the cosine similarity between the search key's vector embedding and those of the plurality of songs.

21. The system of claim 17, wherein a song's vector embedding is indexed within a hierarchical navigable small world graph.

22. The method of claim 18, wherein a song's vector embedding is indexed within a hierarchical navigable small world graph.

23. The system of claim 15, wherein weights used to compute a song's vector embedding are obtained from the minimization of a triplet loss cost function in which every input learning example triplet consists of an anchor, positive, and negative song identifiers in which the anchor is more proximate to the positive than to the negative.

24. The method of claim 16, wherein weights used to compute a song's vector embedding are obtained from the minimization of a triplet loss cost function in which every input learning example triplet consists of an anchor, positive, and negative song identifiers in which the anchor is more proximate to the positive than to the negative.

25. The system of claim 23, wherein the system can algorithmically generate a set of learning example triplets from:
a search key;
a ranked list of similar songs generated by the system with respect to the search key;
a user generated ranked list of similar songs whose songs are drawn from a subset of the system ranked list.

26. The method of claim 24, wherein the system can algorithmically generate a set of learning example triplets from:
a search key;
a ranked list of similar songs generated by the system with respect to the search key;
a user generated ranked list of similar songs whose songs are drawn from a subset of the system ranked list.

27. The system of claim 17, wherein execution is performed in an on-premise environment.

28. The method of claim 18, wherein execution is performed in an on-premise environment.

29. A method for selecting a song from a plurality of songs, the method comprising:
receiving the plurality of songs;
generating one or more block feature vectors for each song in the plurality of songs;
maintaining a list of block feature vectors for each song in the plurality of songs;
normalizing the block feature vectors;
receiving a request comprising a search key song;
generating one or more block feature vectors for the search key song; and
selecting a song from the plurality of songs based on a similarity between the block feature vectors of the selected song and the block feature vectors of the search key song.

30. The method according to claim 29, wherein the similarity between the block feature vectors of the selected song and the block feature vectors of the search key song comprises a proximity between the block feature vectors of the selected song and the block feature vectors of the search key song.

31. The method according to claim 29, wherein generating the block feature vectors comprises extracting one or both of time and spectral domain descriptors.

32. The method according to claim 31, wherein the time and spectral domain descriptors include one or more of: a zero crossing rate, a first order autocorrelation, an energy level, a linear regression, a spectral centroid, a spectral smoothness, a spectral spread, and a spectral dissymmetry.

33. The method according to claim 31, wherein generating the block feature vectors comprises generating one or more statistical moments of the extracted time and spectral domain descriptors.

34. The method according to claim 33, wherein the statistical moments comprise one or more of: a mean, a variance, a skewness, and a kurtosis.

35. The method according to claim 29, wherein generating the block feature vectors comprises generating the block feature vectors via a sliding signal window.

36. The method according to claim 29, further comprising range scaling the block feature vectors.

37. The method according to claim 29, wherein maintaining the list of block feature vectors comprises, for each of the plurality of songs, indexing a combination of one or more of the block feature vectors for the song in a hierarchical navigable small world graph data structure.

38. The method according to claim 29, further comprising adding an additional song to the plurality of songs and updating the list of block feature vectors by: generating one or more block feature vectors for the additional song; and adding the block feature vectors for the additional song to the list of block feature vectors.

39. The method according to claim 38, further comprising:
determining the list of block feature vectors requires renormalization; and
renormalization the list of block feature vectors.

40. The method according to claim 39, wherein determining the list of block feature vectors requires renormalization comprises:
determining a feature range from the list of block feature vectors; and
determining one or more of the block feature vectors for the additional song are outside of the feature range.

41. A system for selecting a song from a plurality of songs, the system comprising:
one or more processors;
one or more computer-readable media storing computer-executable instructions that, when executed on the one or more processors, cause the one or more processors to perform acts comprising:
receiving the plurality of songs;
generating one or more block feature vectors for each song in the plurality of songs;
maintaining a list of block feature vectors for each song in the plurality of songs;
normalizing the block feature vectors;
receiving a request comprising a search key song;
generating one or more block feature vectors for the search key song; and
selecting a song from the plurality of songs based on a similarity between the block feature vectors of the selected song and the block feature vectors of the search key song.

42. The system according to claim 41, wherein the similarity between the block feature vectors of the selected song and the block feature vectors of the search key song comprises a proximity between the block feature vectors of the selected song and the block feature vectors of the search key song.

43. The system according to claim 41, wherein generating the block feature vectors comprises extracting one or both of time and spectral domain descriptors.

44. The system according to claim 43, wherein the time and spectral domain descriptors include one or more of: a zero crossing rate, a first order autocorrelation, an energy level, a linear regression, a spectral centroid, a spectral smoothness, a spectral spread, and a spectral dissymmetry.

45. The system according to claim 43, wherein generating the block feature vectors comprises generating one or more statistical moments of the extracted time and spectral domain descriptors.

46. The system according to claim 45, wherein the statistical moments comprise one or more of: a mean, a variance, a skewness, and a kurtosis.

47. The system according to claim 41, wherein generating the block feature vectors comprises generating the block feature vectors via a sliding signal window.

48. The system according to claim 41, further comprising range scaling the block feature vectors.

49. The system according to claim 41, wherein maintaining the list of block feature vectors comprises, for each of the plurality of songs, indexing a combination of one or more of the block feature vectors for the song in a hierarchical navigable small world graph data structure.

50. The system according to claim 41, further comprising adding an additional song to the plurality of songs and updating the list of block feature vectors by: generating one or more block feature vectors for the additional song; and adding the block feature vectors for the additional song to the list of block feature vectors.

51. The system according to claim 50, further comprising:
determining the list of block feature vectors requires renormalization; and
renormalization the list of block feature vectors.

52. The system according to claim 51, wherein determining the list of block feature vectors requires renormalization comprises:
determining a feature range from the list of block feature vectors; and
determining one or more of the block feature vectors for the additional song are outside of the feature range.
